(19) United States
(12) Patent Application Publication
(10) Pub. No.: US 2007/0242089 A1
(43) Pub. Date: Oct. 18, 2007

(54) Image Display Apparatus and Image Display Method

(75) Inventor: Tomohiro Mukai, Nagano-ken (JP)

Correspondence Address: HARNESS, DICKEY & PIERCE, P.L.C., P.O. BOX 828, BLOOMFIELD HILLS, MI, 48303, US

(73) Assignee: Seiko Epson Corporation, Tokyo (JP)

(21) Appl. No.: 11/631,918

(22) PCT Filed: Jul. 8, 2005
(86) PCT No.: PCT/JP05/13109

§ 371 Date: May 15, 2007

(30) Foreign Application Priority Data
Jul. 9, 2004 (JP) 2004-202738

(51) Int. Cl. G09G 5/00

(52) U.S. Cl. 345/660

(57) ABSTRACT

An image display apparatus includes: a liquid crystal display body 80 having a first display region; an image data acquiring portion 10 that acquires image data having a drawing region of a size larger than a size of the first display region; a virtual display region generating portion 40 that generates a virtual, second display region in substantially the same size as the drawing region; an image data developing portion 50 that develops the image data in the second display region; an image identifying portion 60 that identifies an image to be displayed on the display medium among the image data developed in the second display region with reference to the first display region; and an image display portion 70 that displays the identified image on the display medium.

### TECHNICAL FIELD

The present invention relates to an image display apparatus and an image display method for displaying an electronically recorded image.

### BACKGROUND ART

In a method in the related art for displaying an image on the display screen of an image display terminal in the same size as an image of a printed document, as is disclosed in JP-A-11-219160, a drawing region and a blank region in drawing data of the document are discriminated from each other to eliminate the blank region, then the remaining drawing region is packed, and the drawing region thus packed is enlarged through image processing and displayed.

The method in the related art, however, needs complicated image processing to extract the drawing region from the drawing data of the document for the drawing region to be enlarged and displayed. Further, because the structure of drawing data differs from application to application used to create the document, detailed settings are necessary for each application, which deteriorates the usability of the image display terminal.

### DISCLOSURE OF THE INVENTION

In order to solve the problem discussed above, an image display apparatus of the invention is characterized by including: a display medium having a first display region; an image data acquiring portion that acquires image data having a drawing region of a size larger than a size of the first display region; a virtual display region generating portion that generates a virtual, second display region in substantially a same size as the drawing region; an image data developing portion that develops the image data in the second display region; an image identifying portion that identifies an image to be displayed on the display medium among the image data developed in the second display region with reference to the first display region; and an image display portion that displays the identified image on the display medium.

According to the above configuration, the acquired image data has a drawing region of a size larger than that of the display region of the display medium. It is thus possible to enlarge and display an image without having to subject the image data to enlargement processing. Further, because the image data is processed on the virtual display region, application-independent processing is possible, which eliminates the need for the settings on an application-by-application basis. The usability of the image display terminal can be therefore improved.

In the invention, cases as follows are possible: a case where the image identifying portion identifies the image so that a center position of the first display region is mapped almost on a center position of the second display region; and a case where the display medium is provided on at least one surface the image display apparatus has, and the, image identifying portion identifies the image so that one end of the one surface is mapped almost on one end of the second display region.

In the case where the image identifying portion identifies the image so that the center position of the first display region is mapped almost on the center position of the second display region, it is possible to display an image on the image display apparatus on the basis of the center position.

In the case where the display medium is provided to at least one surface the image display apparatus has, and the image identifying portion identifies the image so that one end of the one surface is mapped almost on one end of the second display region, it is possible to display an image on the image display apparatus on the basis of the almost mapped position.

It is preferable for the invention that the image data is data created on a device driver in an output device that outputs information, and is thereby data that can be outputted from the output device.

According to the above configuration, because the image data is created on the device driver in the output device, it is possible to display substantially the same image as an image outputted from the output device on the image display apparatus.

It is preferable for the invention to further include a data converting portion that converts the acquired image data containing characters and graphics to data that can be outputted from an output device that outputs information.

According to the above configuration, it is possible to convert the input image data to data that can be outputted from the output device by means of the data converting portion.

It is preferable for the invention to further include an image reducing portion that reduces the image data so as to be displayed in the first display region.

According to the above configuration, because an image can be reduced in the image reducing portion to be displayed, it is possible to display the image entirely without missing any part of the image.

It is preferable for the invention to further include a display choosing portion that chooses at least one of a size of the image to be displayed on the display medium and a display position of the image.

According to the above configuration, it is possible to choose the size and the display position of an image to be displayed on the display medium as needed.

In order to solve the problem discussed above, an image display method of the invention is an image display method for displaying an image on a display medium having a first display region, which is characterized by including: a step of inputting data of the image; a step of creating output data having a drawing region of a size larger than a size of the first display region from information about the first display region and the data of the image; a step of generating a virtual, second display region in substantially a same size as the drawing region; a step of developing the output data in the second display region; a step of identifying an image to be displayed in a size of the display region of the display medium among the developed output data, so that a specific position in the first display region is mapped almost on a specific position in the second display region; and a step of displaying the identified data on the display medium.

According to this method, because image data having a drawing region of a size larger than that of the display region of the display medium is acquired and used, there is no need to subject an image to enlargement processing. In addition, because the image data is processed on the virtual display region, application-independent processing is possible, which eliminates the need for the settings on an application-by-application basis. The usability of the image display terminal can be therefore improved.

### BRIEF DESCRIPTION OF THE DRAWINGS

The above and other objects, features, and advantages of the invention will become more apparent from the following description of a preferred embodiment of the invention with reference to the accompanying drawings:

FIG. 1 is an outward configuration view showing the configuration of an electronic portable terminal according to one embodiment of the invention;

FIG. 2 is a view showing the hardware configuration of the electronic portable terminal;

FIG. 3 is a functional block diagram showing the functional configuration of the electronic portable terminal;

FIG. 4 is a flowchart detailing the processing until an image is displayed on the electronic portable terminal; and

FIG. 5 is a view used to describe display examples in display modes of the electronic portable terminal.

### BEST MODE FOR CARRYING OUT THE INVENTION

Hereinafter, one embodiment of the invention will be described using an electronic portable terminal that displays the content of an electronically recorded document as an example of an image display apparatus.

### EMBODIMENT

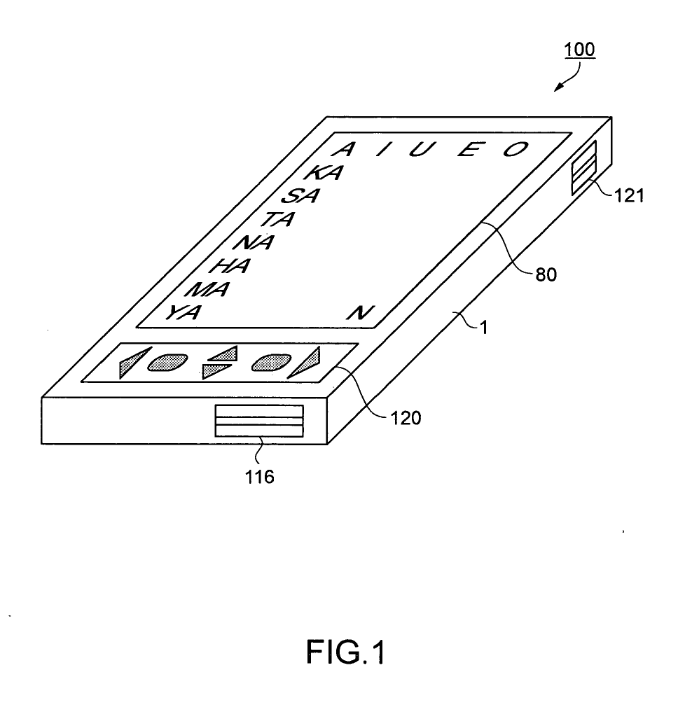

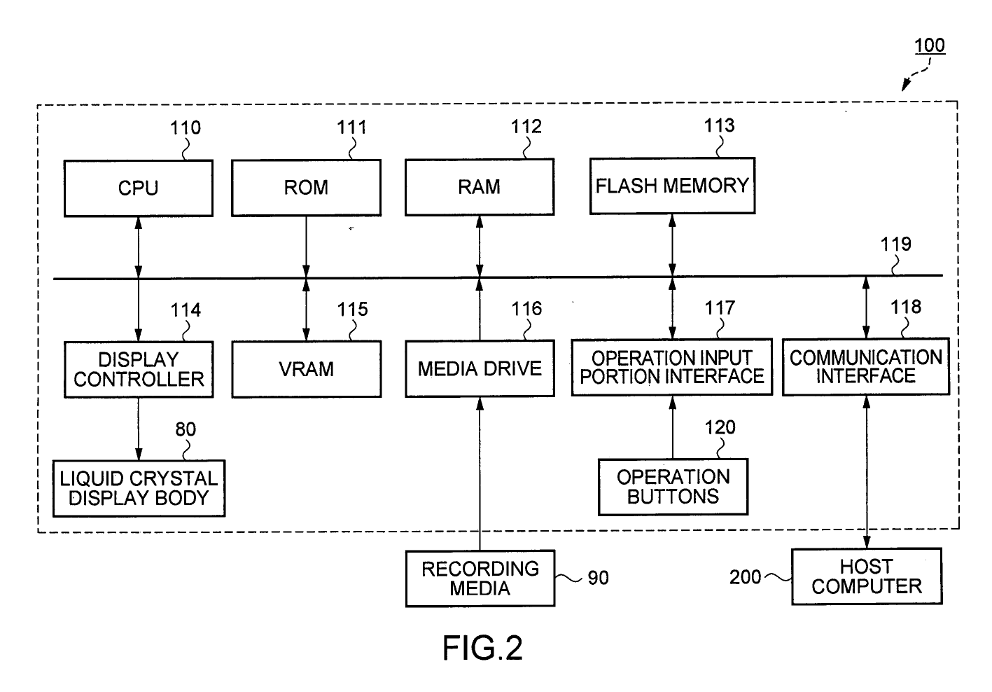

FIG. 1 is an outward configuration view showing the outward configuration of an electronic portable terminal 100 according to one embodiment of the invention. The main surface of the electronic portable terminal 100 is of substantially the same size as A-4 size paper (210 mm×297 mm). A liquid crystal display body 80 that displays the content of an electronic document containing characters and graphics, and operation buttons 120 used to choose an electronic document to be displayed and a display style are provided on the main surface. The liquid crystal display body 80 comprises an LCD (Liquid Crystal Display) and has a display region of 190 mm×250 mm. A USB terminal 121 to be connected to a host computer 200 (FIG. 2) is provided to the electronic portable terminal 100 on one side surface in the longitudinal direction. Further, a media drive 116 that reads data on recording media 90 (FIG. 2) is provided to the electronic portable terminal 100 on one side surface in the lateral direction.

FIG. 2 is a view showing the hardware configuration of the electronic portable terminal 100. The hardware of the electronic portable terminal 100 includes a CPU (Central Processing Unit) 110, a ROM (Read Only Memory) 111, a RAM (Random Access Memory) 112, a flash memory 113, a display controller 114, a VRAM (Video RAM) 115, the media drive 116, an operation input portion interface 117, and a communication interface 118. These hardware resources are interconnected via a bus 119.

The CPU 110 reads out a program stored in the ROM 111 as needed, and develops the program to be stored in the RAM 112.

Further, the CPU 110 controls the respective hardware resources of the electronic portable terminal 100 by reading out and running the program developed in the RAM 112 as needed.

The display controller 114 controls the liquid crystal display body 80 to display data stored in the-VRAM 115 according to an instruction from the CPU 110.

The flash memory 113 stores data temporarily according to an instruction from the CPU 110.

The communication interface 118 is connected to the host computer 200 for data to be sent and received. For example, a USB (Universal Serial Bus) can be adopted as the communication interface 118.

The media drive 116 is a device that reads out information from and writes information in the recording media 90. For example, a CompactFlash® (the registered trademark of SanDisk® Corporation) can be adopted as the recording media 90.

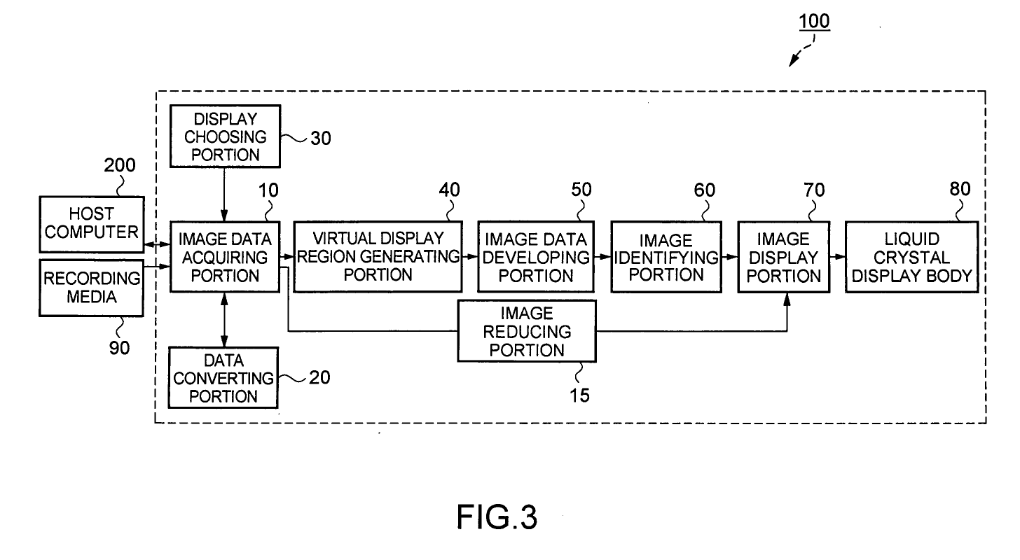

FIG. 3 is a functional block diagram showing the functional configuration of the electronic portable terminal 100. The electronic portable terminal 100 includes an image data acquiring portion 10, a data converting portion 20, a display choosing portion 30, a virtual display region generating portion 40, an image data developing portion 50, an image identifying portion 60, an image display portion 70, the liquid crystal display body 80, and an image reducing portion 15. The respective portions achieve functions described below as the hardware resources and the software stored in the ROM 111 or the like organically collaborate with each other.

The display choosing portion 30 allows the user of the electronic portable terminal 100 to choose a display mode in which an image is displayed on the liquid crystal display body 80. The display mode includes two different modes: “same size display mode” and “reduced display mode”. “Same size display mode” is a mode in which an image is displayed in the same size as the surface of the electronic portable terminal 100, that is, substantially the same size as an image printed on A-4 size paper. The other “reduced display mode” is a mode in which the same image as the printed image is reduced and displayed on the liquid crystal display body 80.

Further, when “same size display mode” is chosen, the display choosing portion 30 allows to choose either “upper left mapping mode” or “center mapping mode.” “Upper left mapping mode” is a mode in which the upper left of the printed image is mapped on the upper left of the electronic portable terminal 100. “Center mapping mode” is a mode in which the center position of the printed image is mapped on the center position of the electronic portable terminal 100.

The user of the electronic portable terminal 100 is able to choose a mode to display among these display modes as he manipulates the operation buttons 120 appropriately by following an unillustrated user interface screen displayed on the liquid crystal display body 80.

The image data acquiring portion 10 acquires image data from the host computer 200 or the recording media 90. To be more specific, the user of the electronic portable terminal 100 chooses image data as he manipulates the operation buttons 120 by following the unillustrated user interface screen displayed on the liquid crystal display body 80. When image data is chosen, the image data acquiring portion 10 starts to read out the image data thus chosen from the host computer 200 or the recording media 90 and acquires the image data.

Incidentally, image data to be acquired is largely divided into two kinds. One is image data that is created on a device driver equipped in the OS (Operating System) of the host computer 200, for example, a printer driver, and is printable in the device, namely, the printer. The printable data referred to herein is defined as data from which a bitmapped image of data can be printed as the printer device that has received the data interprets the received data. To be more concrete, printable data is formed of data of a bitmapped image, data to control the printer device, etc.

The other is data created on application software, such as Microsoft Word of Microsoft Cooperation, USA, and supplied in the form of a file.

The image data acquiring portion 10 is able to judge whether acquired data is printable data by checking whether the acquired data includes a control code for controlling the printer device.

When the judgment result reveals that the acquired data is not printable data, that is, when the acquired data is the data created on application software, the image data acquiring portion 10 converts the acquired data to printable data via the data converting portion 20.

The data converting portion 20 is furnished with a function equivalent to that of the printer driver equipped in the OS of the host computer 200. In short, the data converting portion 20 converts data created on the application software to printable data.

Normally, when the printer driver creates printable data, information of the printer used for printing is transmitted to the printer driver, and the printer driver creates a bitmapped image according to this information. Likewise, information about the ability specific to the liquid crystal display body 80 of the electronic portable terminal 100 is also transmitted from the electronic portable terminal 100 to the printer driver equipped in the host computer 200.

The electronic portable terminal 100 is programmed to notify the printer driver of the display ability higher than the original display ability when “same size display mode” is chosen in the display choosing portion 30. Hence, upon receipt of this information, the printer driver creates a bitmapped image of a region wider than the display region of the liquid crystal display body 80. On the other hand, the electronic portable terminal 100 is programmed to notify the printer driver of the original display ability when “reduced display mode” is chosen in the display choosing portion 30. The display ability notified to the printer driver will be described below.

The virtual display region generating portion 40 generates a virtual display region on the memory when “same size display mode” is chosen in the display choosing mode 30. In other words, the virtual display region generating portion 40 secures a virtual display region (virtual VRAM) within a region on the flash memory 113 in the same size as the drawing region of the printable data created on the printer driver. The virtual display region is therefore generated to be wider than the display region of the liquid crystal display body 80.

The image data developing portion 50 develops the data of the bitmapped image in the virtual display region generated by the virtual display region generating portion 40.

The image identifying portion 60 chooses a region within the virtual display region that suits either of the two modes in “same size display mode” chosen in the display choosing portion 30. In other words, when “upper left mapping mode” is chosen, a region is chosen so that the upper left of the bitmapped image is mapped on the upper left of the electronic portable terminal 100. When the other “center mapping mode” is chosen, a region is chosen so that the center position of the bitmapped image is mapped on the center position of the electronic portable terminal 100. The choosing of these regions will be described in detail below.

The image reducing portion 15 reduces the bitmapped image when “reduced display mode” is chosen in the display choosing portion 30, so that the entire bitmapped image acquired in the image data acquiring portion 10 is displayed on the liquid crystal display body 80 at a time. To be more concrete, the image reducing portion 15 brings the drawing region of the image data into agreement with the display region of the liquid crystal display body 80 by skipping image data appropriately.

The image display portion 70 performs drawing processing by transferring image data to be displayed on the liquid crystal display body 80 to the VRAM 115, while displaying an image of the image data on the liquid crystal display body 80 via an unillustrated display control portion of the liquid crystal display body 80. To be more concrete, when “same size display mode” is chosen in the display choosing portion 30, the image display portion 70 displays an image identified by the image identifying portion 60. On the other hand, when “reduced display mode” is chosen in the display choosing portion 30, the image display portion 70 displays an image reduced on the basis of image data corrected in the image reducing portion 15.

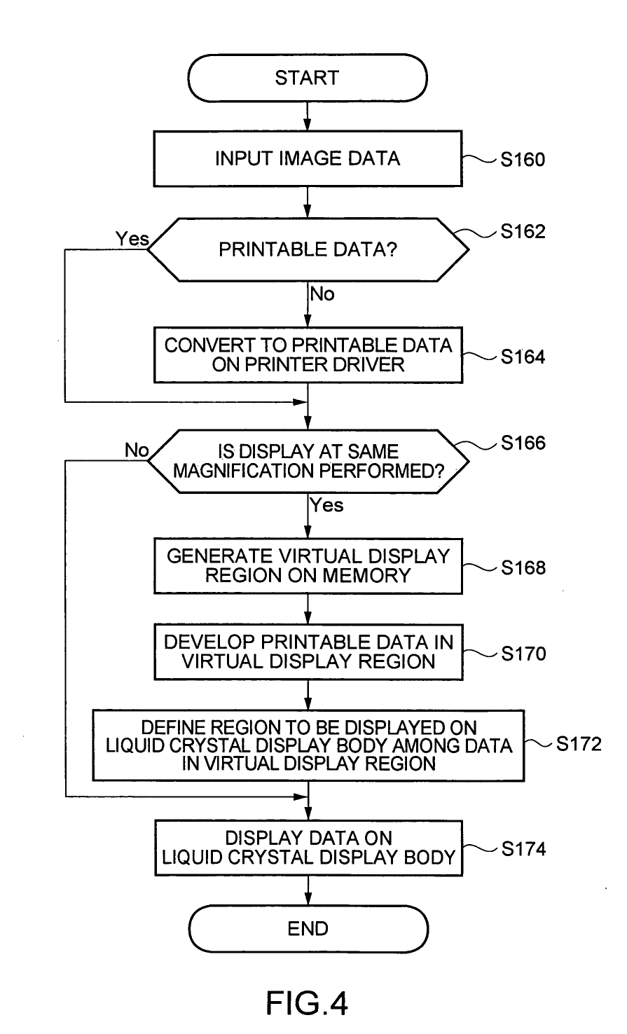

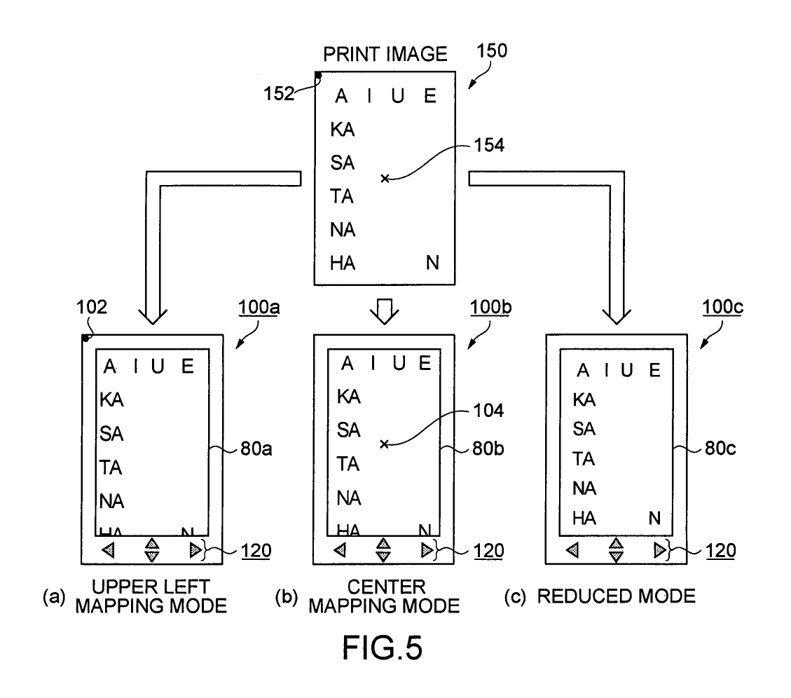

The flow until the acquired image data is displayed on the liquid crystal display body 80 in the configuration of the electronic portable terminal 100 as described above will now be described with reference to FIG. 4 and FIG. 5 in addition to FIG. 3. FIG. 4 is a flowchart detailing the processing until an image is displayed on the electronic portable terminal 100. FIG. 5 is a view used to describe display examples in the respective display modes.

The electronic portable terminal 100 first performs a step of inputting image data when it is started as the power supply is switched ON. In other words, the electronic portable terminal 100 inputs image data from the host computer 200 or the recording media 90 (Step S160).

Subsequently, the electronic portable terminal 100 judges whether input image data is printable data created on the printer driver (Step S162).

When the input image data is judged to be printable data (Yes in Step S162), the electronic portable terminal 100 proceeds to a step (Step S166) where whether the mode chosen in the display choosing portion 30 is a same magnification mode.

When the input image data is not judged to be printable data (No in Step S162), the electronic portable terminal 100 converts the input image data to printable data via the printer driver in the data converting portion 20 (Step S164).

Herein, assume that a paper size for the image data is an A-4 size, the pixel drawing ability of the liquid crystal display body 80 is 200 PPI (200 pixels per inch), and “same size display mode” is chosen in the display choosing portion 30. Then, the printer driver performs a step where a bitmapped image, having a drawing region of a size larger than a pixel size (1496 pixels×1968 pixels) that can be displayed on the liquid crystal display body 80, is generated. That is to say, the printer driver acquires information as follows from the electronic portable terminal 100.
(1) The document size is an A-4 size.
(2) The resolution of a display medium is 200 PPI.
(3) The size of the display medium is 210 mm×297 mm.

Subsequently, the printer driver creates a bitmapped image made of 1654 pixels×2339 pixels and printable on A-4 size paper from the acquired data.

On the other hand, when “reduced display mode” is chosen in the display choosing portion 30, the printer driver acquires information as follows from the electronic portable terminal 100.
(1) The document size is an A-4 size.
(2) The resolution of a display medium is 200 PPI.
(3) The size of the display medium is 190 mm×250 mm.

As in “same size display mode” described above, the printer driver creates a bitmapped image made of 1496 pixels×1968 pixels and printable on A-4 size paper from the acquired data.

Referring to the flowchart again, the electronic portable terminal 100 subsequently judges whether the mode chosen in the display choosing portion 30 is “same size display mode” in which display at the same magnification is performed (Step S166).

When “reduced display mode” is chosen in the display choosing portion 30 (No in Step S166), the electronic portable terminal 100 proceeds to a step (Step S174) where data of the chosen bitmapped image is displayed on the liquid crystal display body.

When “same size display mode” is chosen in the display choosing portion 30 (Yes in Step S166), the electronic portable terminal 100 performs a step (Step S168) where the printer driver generates a virtual display region of a size large enough to hold the drawing image on the memory. To be more concrete, the electronic portable terminal 100 secures a region (virtual VRAM) to hold a bitmapped image made of 1654 pixels×2339 pixels created on the printer driver on the flash memory 113.

Subsequently, the electronic portable terminal 100 performs a step (Step S170) where it develops the printable data in the virtual display region. To be more concrete, the image data developing portion 50 transfers data of the bitmapped image created on the printer driver to the region secured on the flash memory 113.

Subsequently, the electronic portable terminal 100 performs a step (Step S172) where a region to be displayed on the liquid crystal display body is identified among the data in the virtual display region, so that a specific position in the liquid crystal display body 80 is mapped almost on a specific position in the virtual display region. To be more concrete, of the image data (1654 pixels×2339 pixels) stored in the virtual VRAM on the flash memory 113, the image identifying portion 60 identifies a region of a pixel size (1496 pixels×1968 pixels) that can be displayed on the liquid crystal display body 80 as the region to be displayed on the liquid crystal display body 80 in response to the display mode chosen in the display choosing portion 30. A difference of displays among the respective display modes will now be described with reference to FIG. 5.

Firstly, when “upper left mapping mode” is chosen in the display choosing portion 30, as is shown in (a) upper left mapping mode, the image identifying portion 60 chooses image data in the virtual VRAM appropriately, so that an upper left end point 152 on the print image 150 is mapped on an upper left end point 102 on the electronic portable terminal 100 on a liquid crystal display body 80a. In other words, the image identifying portion 60 chooses pixel data of 1496 pixels×1968 pixels starting from a pixel displaying the upper left end portion among the image data in the virtual VRAM, while identifying the pixel data thus chosen as a region to be displayed on the liquid crystal display body 80.

On the other hand, when “center mapping mode” is chosen in the display choosing portion 30, as is shown in (b) center mapping mode, the image identifying portion 60 chooses data in the virtual VRAM appropriately, so that a center position 154 of the print image 150 is mapped on a center position 104 of the electronic portable terminal 100 on a liquid crystal display body 80b. In other words, the image identifying portion 60 chooses pixel data of 1496 pixels×1968 pixels uniformly in reference to the center position of the image from the image data in the virtual VRAM, while identifying the pixel data thus chosen as a region to be displayed on the liquid crystal display body 80.

Referring to FIG. 4 again, the electronic portable terminal 100 subsequently performs a step (Step S174) where the image data thus identified is displayed on the liquid crystal display body.

The bitmapped image is displayed on the liquid crystal display body 80 according the respective display modes shown in FIG. 5 by the steps as has been described. In other words, in the case of (a) upper left mapping mode and (b) center mapping mode both in “same size display mode”, the bitmapped images are displayed in the same size as the print image 150 as are shown on the liquid crystal display body 80a and the liquid crystal display body 80b, respectively. In the case of (c) reduced mode, the bitmapped image is displayed as it is reduced so that the entire image of the print image 150 is fit within a liquid crystal display body 80c.

The embodiment described above has advantages as follows.
(1) In “same size display mode”, a bitmapped image displayed on the liquid crystal display body 80 and a print image printed on paper are displayed in the same size. The user is therefore able to confirm the same image as the print image by displaying the image on the liquid crystal display body 80 before it is printed on paper.
(2) By selecting “same size display mode”, it is possible to display an image by removing a certain region in a blank portion that is automatically created in the vicinity of the bitmapped image on the application software.
(3) For some contents to be displayed, the content may be displayed with part thereof missing when displayed in “same size display mode”; however, missing of the content can be avoided by choosing “reduced display mode” in which the bitmapped image is reduced so that is displayed entirely.
(4) Because the bitmapped image to be displayed is created on the printer driver, there is no need to provide special bitmapped image creating software to acquire a bitmapped image equivalent to the print image. It is thus possible to provide the electronic portable terminal 100 that displays a print image at a lower cost.

While the image display apparatus of the invention has been described by way of the embodiment shown in the drawings, the invention is not limited to the embodiment above, and modifications as follows are conceivable.
(1) A display medium on which a bitmapped image is displayed is not limited to the liquid crystal display body, and it may be a display medium provided with a display and memory capability as in the electrophoresis method using micro capsules.
(2) The device driver to create image data is not limited to the printer driver. For example, given the electronic portable terminal 100 as the device, then a device driver that writes data in a format specific to the electronic portable terminal 100 may be used.
(3) The respective steps in the image display method for displaying an image are not limited to the functions on the electronic portable terminal 100 side, and part of the functions may be allocated to the host computer 200.

1. An image display apparatus characterized by comprising:
a display medium having a first display region;
an image data acquiring portion that acquires image data having a drawing region of a size larger than a size of the first display region;
a virtual display region generating portion that generates a virtual, second display region in substantially a same size as the drawing region;
an image data developing portion that develops the image data in the second display region;
an image identifying portion that identifies an image to be displayed on the display medium among the image data developed in the second display region with reference to the first display region; and
an image display portion that displays the identified image on the display medium.

2. The image display apparatus according to claim 1, wherein:
the image identifying portion identifies the image so that a center position of the first display region is mapped almost on a center position of the second display region.

3. The image display apparatus according to claim 1, wherein:
the display medium is provided on at least one surface the image display apparatus has; and
the image identifying portion identifies the image so that one end of the surface is mapped almost on one end of the second display region.

4. The image display apparatus according to claim 1, wherein:
the image data is data created on a device driver in an output device that outputs information, and is thereby data that can be outputted from the output device.

5. The image display apparatus according to claim 1, further comprising:
a data converting portion that converts the acquired image data containing characters and graphics to data that can be outputted from an output device that outputs information.

6. The image display apparatus according to claim 1, further comprising:
an image reducing portion that reduces the image data so as to be displayed in the first display region.

7. The image display apparatus according to claim 1, further comprising:
a display choosing portion that chooses at least one of a size of the image to be displayed on the display medium and a display position of the image.

8. The image display apparatus according to claim 2, wherein:
the image data is data created on a device driver in an output device that outputs information, and is thereby data that can be outputted from the output device.

9. The image display apparatus according to claim 2, further comprising:
a data converting portion that converts the acquired image data containing characters and graphics to data that can be outputted from an output device that outputs information.

10. The image display apparatus according to claim 3, wherein:
the image data is data created on a device driver in an output device that outputs information, and is thereby data that can be outputted from the output device.

11. The image display apparatus according to claim 3, further comprising:
a data converting portion that converts the acquired image data containing characters and graphics to data that can be outputted from an output device that outputs information.

12. The image display apparatus according to claim 8, further comprising:
an image reducing portion that reduces the image data so as to be displayed in the first display region.

13. The image display apparatus according to claim 9, further comprising:
an image reducing portion that reduces the image data so as to be displayed in the first display region.

14. The image display apparatus according to claim 10, further comprising:
an image reducing portion that reduces the image data so as to be displayed in the first display region.

15. The image display apparatus according to claim 11, further comprising:
an image reducing portion that reduces the image data so as to be displayed in the first display region.

16. The image display apparatus according to claim 12, further comprising:
a display choosing portion that chooses at least one of a size of the image to be displayed on the display medium and a display position of the image.

17. The image display apparatus according to claim 13, further comprising:
a display choosing portion that chooses at least one of a size of the image to be displayed on the display medium and a display position of the image.

18. The image display apparatus according to claim 14, further comprising:
a display choosing portion that chooses at least one of a size of the image to be displayed on the display medium and a display position of the image.

19. The image display apparatus according to claim 15, further comprising:
a display choosing portion that chooses at least one of a size of the image to be displayed on the display medium and a display position of the image.

20. An image display method for displaying an image on a display medium having a first display region, the method being characterized by comprising:
a step of inputting data of the image;
a step of creating output data having a drawing region of a size larger than a size of the first display region from information about the first display region and the data of the image;
a step of generating a virtual, second display region in substantially a same size as the drawing region;
a step of developing the output data in the second display region;
a step of identifying an image to be displayed in a size of the display region of the display medium among the developed output data, so that a specific position in the first display region is mapped almost on a specific position in the second display region; and
a step of displaying the identified data on the display medium.
